(19) United States
(12) Patent Application Publication
(10) Pub. No.: US 2026/0028005 A1
(43) Pub. Date: Jan. 29, 2026

(54) Parking Brake for Towable Trailer and Method of Using Same

(71) Applicant: Crews Lock LLC, Raleigh, NC (US)

(72) Inventor: Derek T. Crews, Maysville, NC (US)

(73) Assignee: Crews Lock LLC, Raleigh, NC (US)

(21) Appl. No.: 19/256,710

(22) Filed: Jul. 1, 2025

Related U.S. Application Data
(60) Provisional application No. 63/676,546, filed on Jul. 29, 2024.

(51) Int. Cl. B60T 11/08; B60T 1/04; B60T 7/10; B62D 63/06

(52) U.S. Cl. CPC B60T 11/08; B60T 1/04; B60T 7/104; B62D 63/062

(57) ABSTRACT

A parking brake system. The parking brake system may include a braking assembly frame having a front end portion and a second end portion; a pressure bar disposed at the second end portion of the braking assembly frame, wherein the pressure bar may be configured to apply a braking force to a tire in a first state and to remove the braking force in a second state; and a braking control actuator operatively linked to the braking assembly frame, wherein the braking control actuator may be configured to cause the braking assembly frame to move the pressure bar between the first state and the second state.

### RELATED APPLICATIONS

This application is related and claims priority to U.S. Provisional Patent Application No. 63/676,546, filed on Jul. 29, 2024, the application of which is incorporate herein by reference in its entirety.

### TECHNICAL FIELD

The subject matter relates generally to a parking brake system, and more particularly to a parking brake system for a trailer and method of using same.

### BACKGROUND

Electric, hydraulic, and/or pneumatic parking brake systems for towable trailers can be complex, expensive, and unreliable, especially if set on for long periods of time. Electric, hydraulic, pneumatic, and even mechanical parking brake systems for towable trailers are typically installed inside the wheel hubs, all adding to complexity and cost. Therefore, new approaches are needed with respect to providing simple low-cost brake systems for towable trailers.

### SUMMARY

In one embodiment, a parking brake system is provided. The parking brake system may include a braking assembly frame having a front end portion and a second end portion; a pressure bar disposed at the second end portion of the braking assembly frame, wherein the pressure bar may be configured to apply a braking force to a tire in a first state and to remove the braking force in a second state; and a braking control actuator operatively linked to the braking assembly frame, wherein the braking control actuator may be configured to cause the braking assembly frame to move the pressure bar between the first state and the second state. The braking control actuator may include a remote braking controller. The braking control actuator may be mechanically coupled to the front end portion of the braking assembly frame. The braking assembly frame may be adjustable to accommodate different tire sizes or braking pressures. The braking assembly frame may further include a center bar; a rear crossbar attached to a distal end of the center bar; and one or more diagonal support bars, wherein the one or more diagonal support bars may be attached at a first end to the center bar and at a second end to the rear crossbar. The parking brake system may further include an adjustment mechanism, wherein the adjustment mechanism may be operatively linked to the braking assembly frame and may be configured to adjust the position of the pressure bar relative to a surface of the tire. The adjustment mechanism may include an adjustment bar, wherein a threaded portion of a proximal end of the center bar may be configured to thread into a receiving end portion of the adjustment bar, and wherein a rotation of the adjustment bar corresponds with an adjustment of the position of the pressure bar relative to the surface of the tire. The adjustment bar may further include a first collar plate and a second collar plate spaced apart from the first collar plate, and wherein the braking control actuator may be operatively linked to the braking assembly frame at a point between the first collar plate and the second collar plate.

In another embodiment, a trailer with a parking brake system is provided. The trailer with the parking brake system may include a trailer having one or more tires; and a parking brake system. The parking brake system may include a braking assembly frame having a front end portion and a second end portion; one or more pressure bars disposed at the second end portion of the braking assembly frame, wherein the one or more pressure bars may be configured to apply a braking force to one or more of the one or more tires in a first state and to remove the braking force in a second state; and a braking control actuator operatively linked to the braking assembly frame, wherein the braking control actuator may be configured to cause the braking assembly frame to move the one or more pressure bars between the first state and the second state. The braking control actuator of the parking brake system may include a remote braking controller. The braking control actuator of the parking brake system may be mechanically coupled to the front end portion of the braking assembly frame. The braking assembly frame of the parking brake system may be adjustable to accommodate different tire sizes or braking pressures. The braking assembly frame of the parking brake system may further include a center bar; a rear crossbar attached to a distal end of the center bar; and one or more diagonal support bars, wherein the one or more diagonal support bars may be attached at a first end to the center bar and at a second end to the rear crossbar. The parking brake system may further include an adjustment mechanism, wherein the adjustment mechanism may be operatively linked to the braking assembly frame and configured to adjust the position of the one or more pressure bars relative to a surface of one or more of the one or more tires. The adjustment mechanism may include an adjustment bar, wherein a threaded portion of a proximal end of the center bar may be configured to thread into a receiving end portion of the adjustment bar, and wherein a rotation of the adjustment bar corresponds with an adjustment of the position of the one or more pressure bars relative to the surface of one or more of the one or more tires. The adjustment bar may further include a first collar plate and a second collar plate spaced apart from the first collar plate, and wherein the braking control actuator may be operatively linked to the braking assembly frame at a point between the first collar plate and the second collar plate.

In yet another embodiment, a method of using a parking brake system is provided. The method may include providing a trailer having one or more tires and a parking brake system, wherein the parking brake system may include a braking assembly frame having a front end portion and a second end portion; a pressure bar disposed at the second end portion of the braking assembly frame, wherein the pressure bar may be configured to apply a braking force to a tire in a first state and to remove the braking force in a second state; and a braking control actuator operatively linked to the braking assembly frame, wherein the braking control actuator may be configured to cause the braking assembly frame to move the pressure bar between the first state and the second state. The method may further include activating the braking control actuator to the first state to engage the pressure bar with the tire of the trailer; and deactivating the braking control actuator to the second state to disengage the pressure bar from the tire of the trailer. The method may further include adjusting the position of the pressure bar relative to the surface of the tire via an adjustment mechanism, wherein the adjustment mechanism may be operatively linked to the braking assembly frame and configured to adjust the position of the pressure bar relative to a surface of the tire. The adjustment mechanism may include an adjustment bar, wherein a threaded portion of a proximal end of the center bar may be configured to thread into a receiving end portion of the adjustment bar, and wherein a rotation of the adjustment bar corresponds with an adjustment of the position of the pressure bar relative to the surface of the tire. The adjustment bar may further include a first collar plate and a second collar plate spaced apart from the first collar plate, and wherein the braking control actuator may be operatively linked to the braking assembly frame at a point between the first collar plate and the second collar plate.

### BRIEF DESCRIPTION OF THE DRAWINGS

Having thus described the subject matter in general terms, reference will now be made to the accompanying drawings, which are not necessarily drawn to scale, and wherein:

FIG. 1A and FIG. 1B illustrate schematic views of an example of a parking brake system in a disengaged and an engaged state, respectively, in accordance with an embodiment of the invention;

FIG. 2 through FIG. 12 illustrates various views of an example of the parking brake system shown in FIG. 1A and FIG. 1B, in accordance with an embodiment of the invention;

FIG. 13 illustrates a flow diagram of an example method of using the parking brake system shown in FIG. 1A though FIG. 12, in accordance with an embodiment of the invention; and

FIG. 14A and FIG. 14B illustrate schematic views of another example parking brake system in a disengaged and an engaged state, respectively, in accordance with an embodiment of the invention.

### DETAILED DESCRIPTION

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure will satisfy applicable legal requirements. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides a parking brake for a trailer and method of using same.

In some embodiments, a parking brake system and method is provided that includes a brake control lever operatively coupled to a front portion of a parking brake assembly frame and wherein a back portion of the parking brake assembly frame is operatively coupled to one or more brake or pressure bars arranged near one or more tires, respectively, of the towable trailer.

In some embodiments, a parking brake system and method is provided that includes a brake control lever operatively coupled to a front portion of a parking brake assembly frame and wherein a back portion of the parking brake assembly frame is mechanically coupled to two brake or pressure bars arranged near two tires (one on each side), respectively, of the trailer.

In some embodiments, a parking brake system and method is provided that includes a brake control lever, a parking brake assembly frame, and one or more brake or pressure bars arranged near one or more tires, respectively, of the trailer and wherein the brake control lever is used to engage and/or disengage the one or more brake or pressure bars against the surface of the one or more tires, respectively, of the trailer.

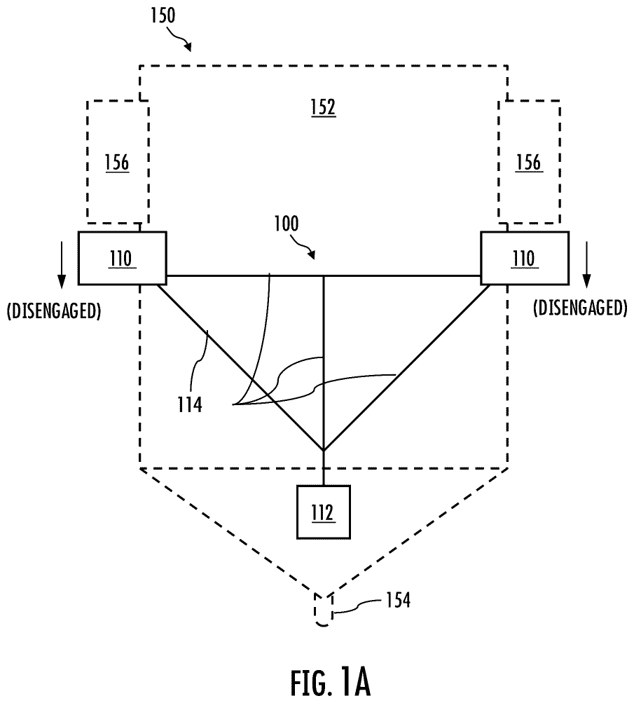

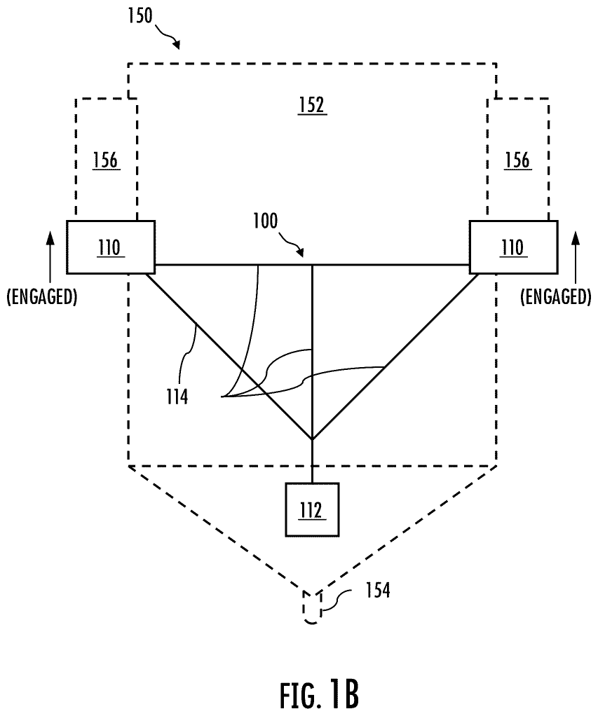

Referring now to FIG. 1A and FIG. 1B is schematic views of an example of a parking brake system 100 for a trailer 150, such as a towable trailer. Parking brake system 100 may include one or more brake or pressure bars 110 in the disengaged and the engaged state, respectively, in accordance with an embodiment of the invention. That is, FIG. 1A and FIG. 1B show parking brake system 100 installed in a trailer, such as trailer 150. In this example, trailer 150 may include a trailer body 152, a trailer tongue 154 at the front of trailer body 152, a first tire (or wheel) 156 on one side of trailer body 152, and a second tire (or wheel) 156 on the other side of trailer body 152.

In one non-limiting embodiment, parking brake system 100 may include one or more brake or pressure bars 110, for example, a first brake (or pressure) bar 110 arranged near the first tire 156 on one side of trailer body 152 of trailer 150, and a second brake (or pressure) bar 110 arranged near the second tire 156 on other side of trailer body 152. Further, parking brake system 100 may include a brake control lever 112 that may be operatively coupled to an arrangement of brake assembly members 114. For example, brake control lever 112 may be coupled to a front portion of brake assembly members 114 and while a rear portion of brake assembly members 114 may be coupled to the first and second brake bars 110 (one on each side).

In one example, the first and second brake bars 110 are designed to come into direct contact with and apply braking pressure to the surface of the first and second tires 156, respectively, of trailer 150. Accordingly, parking brake system 100 provides a simple low-cost parking brake system that does not require components arranged inside the wheel hubs of the trailer 150. Brake assembly members 114 are designed to transfer forces from brake control lever 112 to the brake bars 110 of parking brake system 100 and then accordingly apply braking pressure to, in this example, tires 156 of trailer 150.

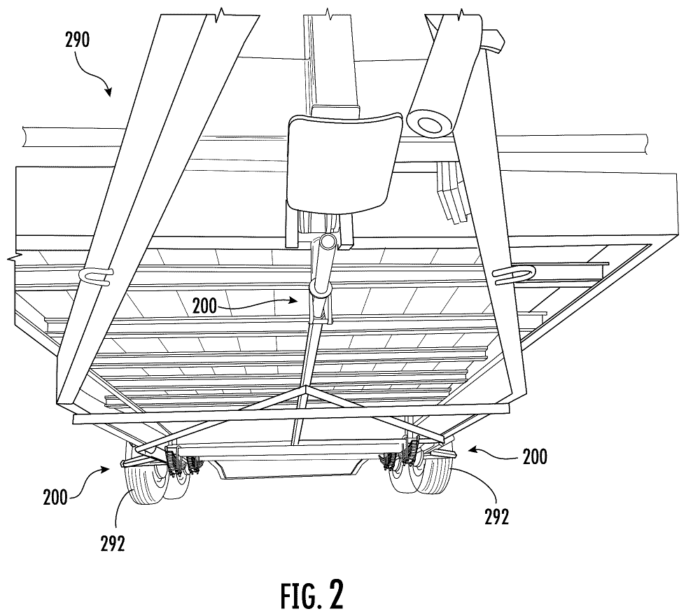

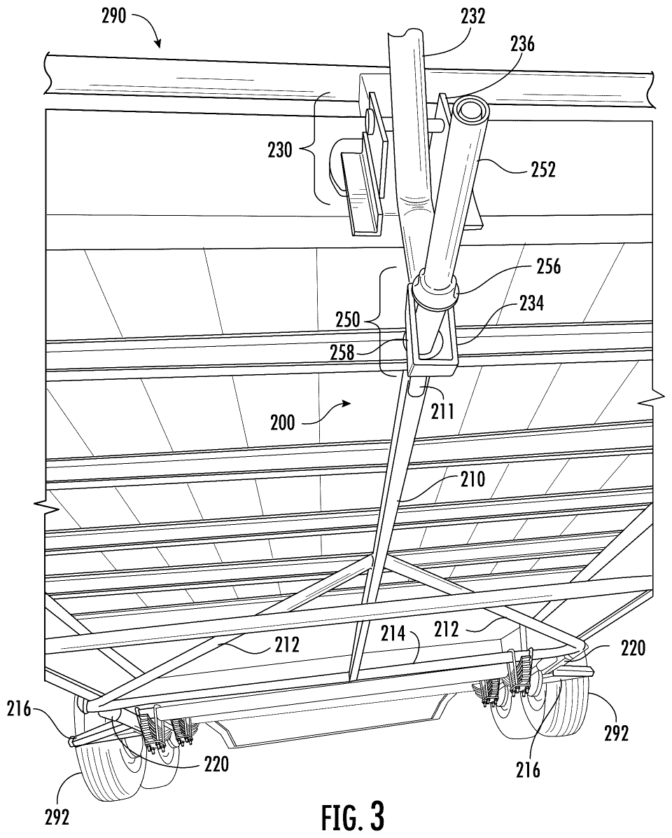

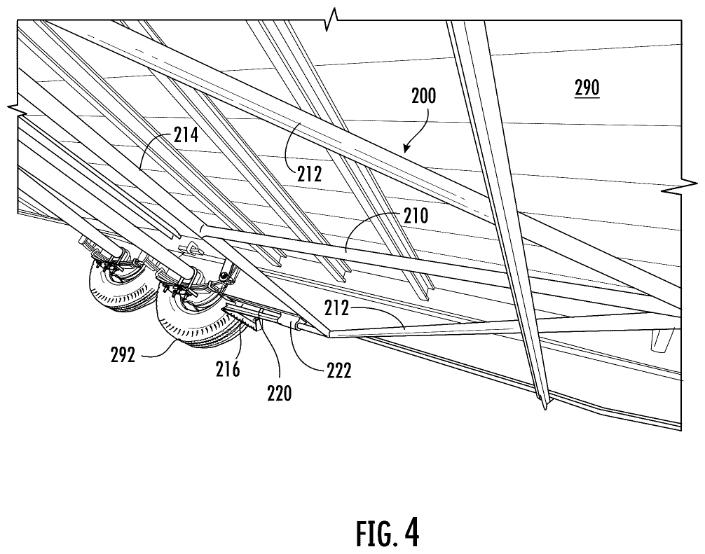

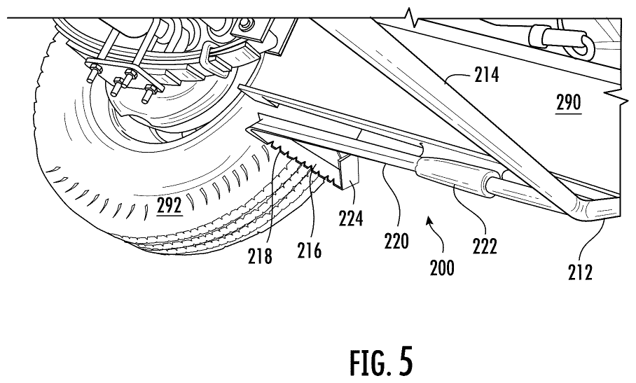

In one example, FIG. 1A shows parking brake system 100 wherein the brake bars 110 are disengaged from tires 156 of trailer 150. That is, brake bars 110 are not in contact with the outside tread of tires 156 by control of brake control lever 112. By contrast, FIG. 1B shows parking brake system 100 wherein the brake bars 110 are engaged with tires 156 of trailer 150. That is, brake bars 110 are in contact with the outside tread of tires 156 by control of brake control lever 112. Here, brake bars 110 are holding braking pressure against tires 156 of trailer 150. More details of an example of one implementation of parking brake system 100 are shown and described below in FIG. 2 through FIG. 12.

Referring now to FIG. 2 through FIG. 12 illustrate an example parking brake system 200, which one example implementation of parking brake system 100 shown in FIG. 1A and FIG. 1B, in accordance with an embodiment of the invention. For example, FIG. 2 illustrates a parking brake system 200 installed on a trailer 290. In this example, trailer 290 may include tandem wheels (i.e., two wheels on each side) and therefore including, for example, four tires 292. Accordingly, in this example, parking brake system 200 is installed with respect to the two frontmost tires 292 of trailer 290.

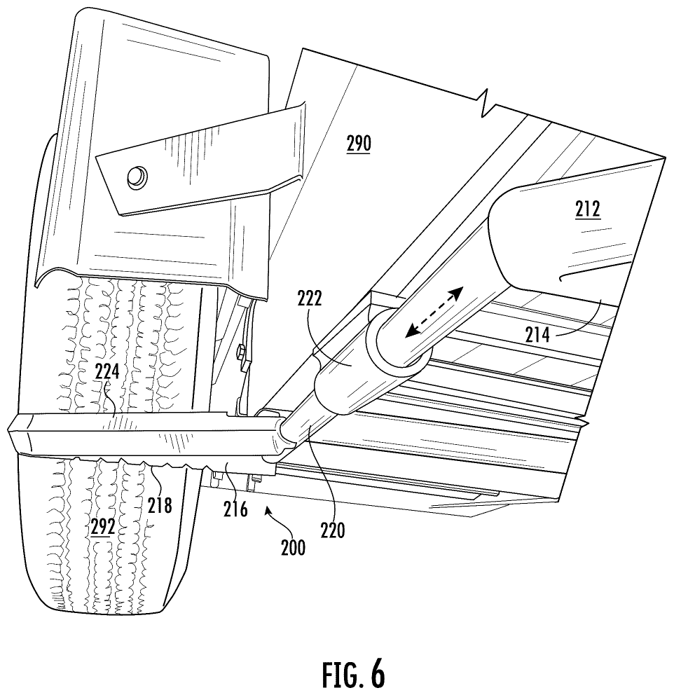

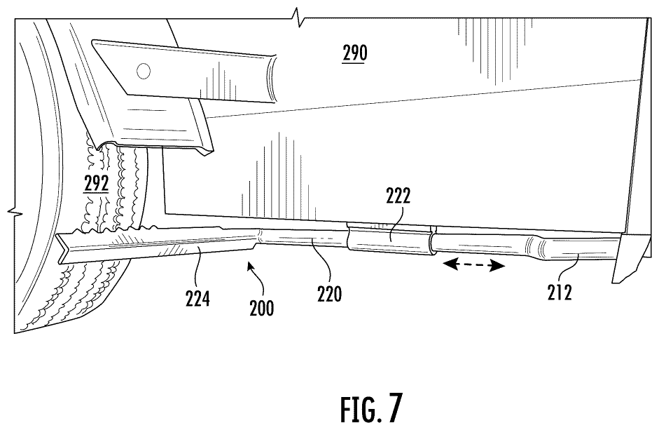

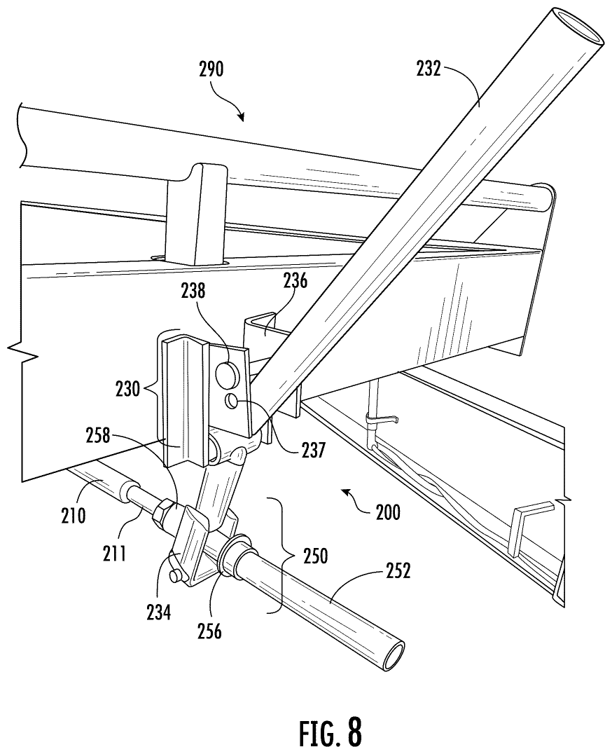

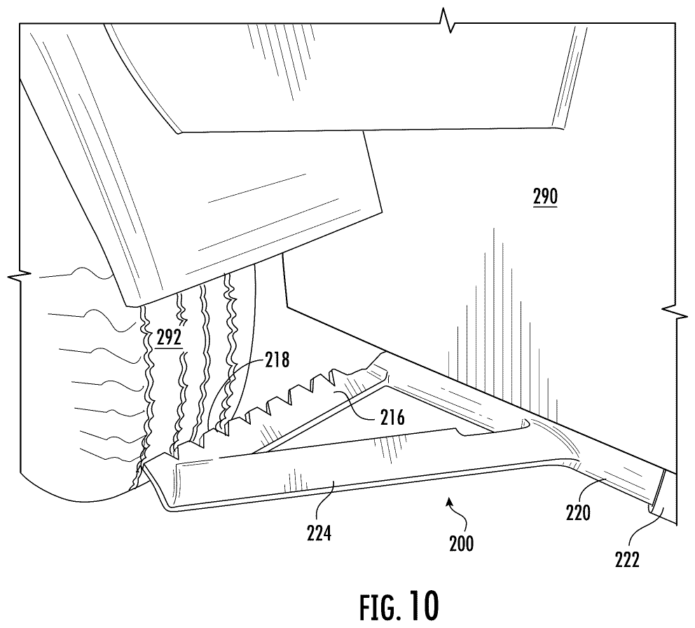

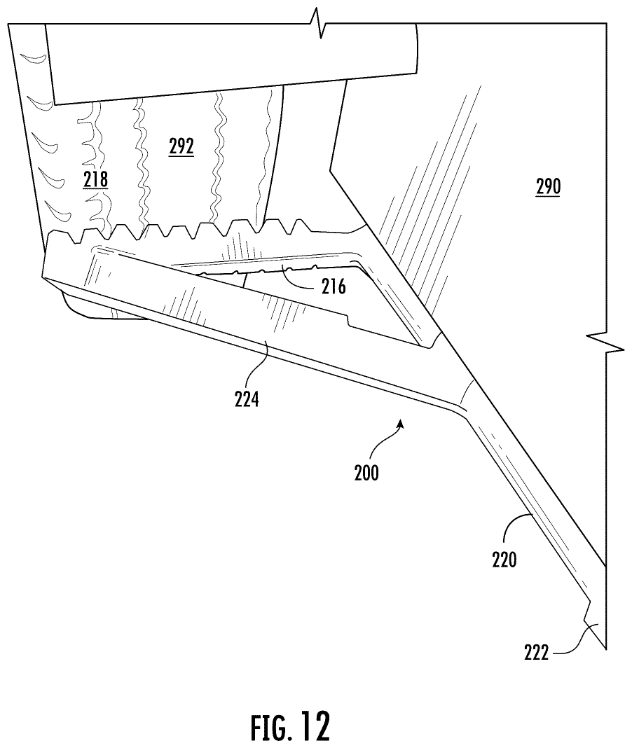

Parking brake system 200 may include, for example, a center bar 210, a first and second diagonal support bar 212, a rear crossbar 214, a first and second brake pressure bar 216 and each may include a profiled edge 218 (see FIG. 10, FIG. 12). Each of the first and second brake pressure bars 216 (along with other support members 224) may be installed at the rearmost end of a support bar 220 that may be a rod that is slidable through a sleeve 222 (see FIG. 6, FIG. 7, FIG. 10, FIG. 12). Further, the frontmost end of center bar 210 may include a threaded end portion 211 (see FIG. 8).

In parking brake system 200, center bar 210, the two diagonal support bars 212, rear crossbar 214, and the two support bars 220, may be an example of brake assembly members 114 of parking brake system 100. Further, brake pressure bars 216 with their other support members 224 may be an example of brake (or pressure) bars 110 of parking brake system 100.

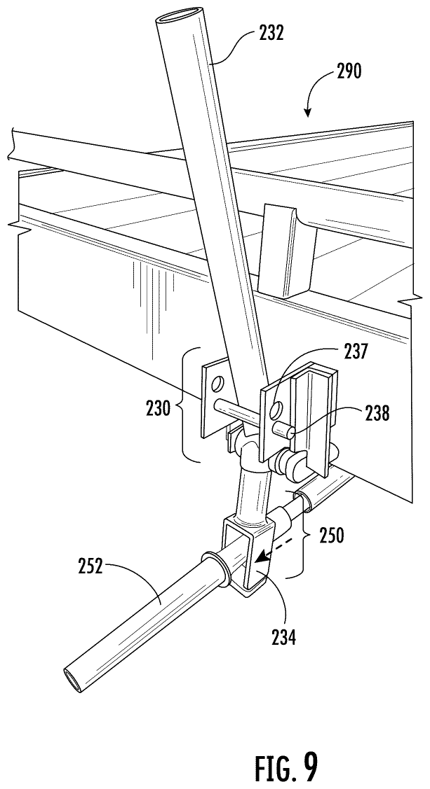

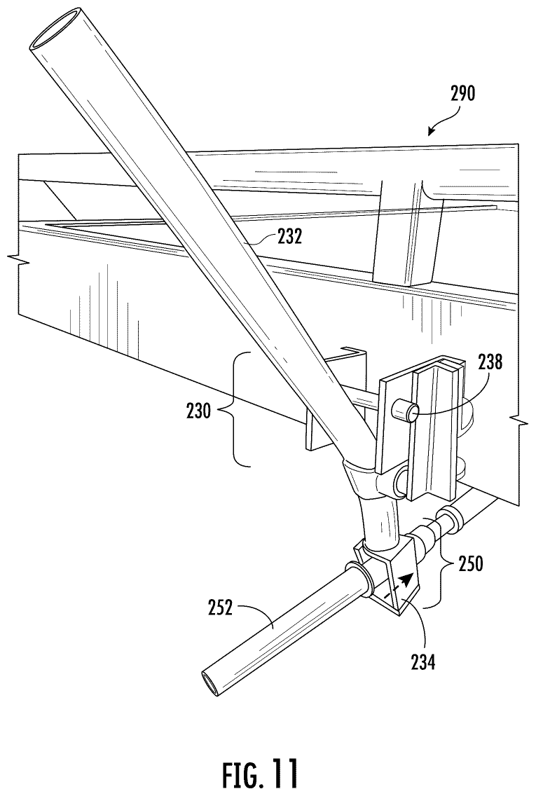

Referring now to FIG. 8, FIG. 9, and FIG. 11, parking brake system 200 may also include a lever assembly 230 that may include a brake control lever 232 that is coupled (e.g., hingeably or pivotably) to the frame of trailer 290, a lower bracket 234, a lock 236 (such as a 2-position), that may include a locking pin 238 and through-holes 237 (e.g., two). Lower bracket 234 of brake control lever 232 may engage with an adjustment collar 250.

Adjustment collar 250 may include, for example, an adjustment bar 252 having a front collar plate 256 and a rear collar plate 258. The threaded end portion 211 at the front end of center bar 210 may be threaded into one end of adjustment bar 252 of adjustment collar 250. In parking brake system 200, lever assembly 230 and adjustment collar 250 may be an example of brake control lever 112 of parking brake system 100.

Referring still to FIG. 2 through FIG. 12, generally the components of parking brake system 200 may be any type of metal framing and/or support members, such as hollow or solid rods, pipes, and/or angle iron members.

In one example, parking brake system 200 may be set in the “disengaged” state. For example, FIG. 9 shows brake control lever 232 of lever assembly 230 in the “disengaged” position. Here, for example, with an upper and a lower through-hole 237 of lever assembly 230, locking pin 238 may be installed in the lower through-hole 237 and with brake control lever 232 behind pin 238. In doing so, center bar 210 may be pulled forward and away from tires 292. FIG. 10 shows the resulting position of brake pressure bar 216 such that its profiled edge 218 is not pressed against the surface of tire 292 of trailer 290. That is, no braking force is being applied to tire 292.

In another example, parking brake system 200 may be set in the “engaged” state. For example, FIG. 11 shows brake control lever 232 of lever assembly 230 in the “engaged” position. Here, for example, with an upper and lower through-hole 237 of lever assembly 230, locking pin 238 is installed in the upper through-hole 237 and with brake control lever 232 in front of pin 238. In doing so, center bar 210 may be pushed backward and toward tires 292. FIG. 12 shows the resulting position of brake pressure bar 216 such that its profiled edge 218 is now pressed against the surface of tire 292 of trailer 290. That is, braking force is being applied to tire 292. Also note that the profiled edge 218 of brake pressure bar 216 is designed to provide suitable friction force and braking force against any tire, yet without doing damage to any tire.

Further, in parking brake system 200, adjustment collar 250 may be used to adjust and ensure the proper amount of braking force of brake pressure bars 216 against, for example, tires 292. The proper amount of braking force means a braking force that is suitably strong to prevent a towable trailer from rolling when parked while at the same time ensuring no damage to tires 292 by brake pressure bars 216. Generally, in parking brake system 200, adjustment collar 250 may be used to adjust for different size tires or amounts of pressure applied to tire. For example, by turning adjustment bar 252. Further, while adjustment collar 250 may be a threaded collar, it is noted that any other suitable adjustment mechanisms are possible, not limited to threaded adjustment mechanisms.

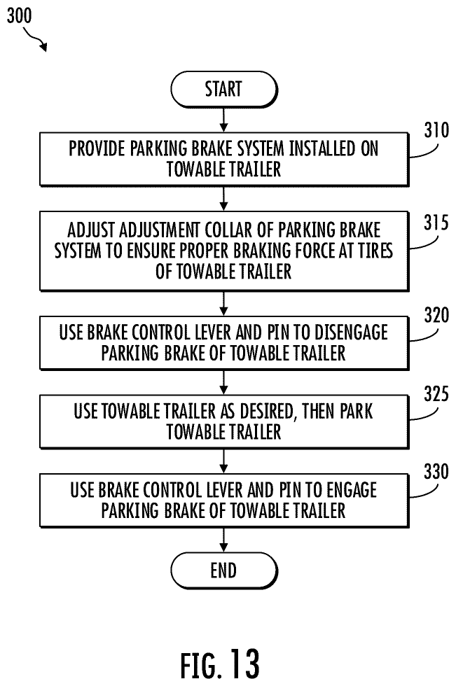

Referring now to FIG. 13 is a flow diagram of an example of a method 300 of using the parking brake systems 100, 200 shown in FIG. 1A though FIG. 12, in accordance with an embodiment of the invention. Method 300 may include, but is not limited to, the following steps.

At a step 310, a parking brake system is provided for a trailer. In one example, parking brake system 100 may be part of or installed on a trailer 150, as shown in FIG. 1A and FIG. 1B. In another example, parking brake system 200 may be part of or installed on a trailer 290, as shown in FIG. 2 through FIG. 12.

At a step 315, the parking brake system is adjusted to ensure the proper braking force at the tires of the trailer. For example and referring to FIG. 2 through FIG. 12, adjustment bar 252 of adjustment collar 250 of parking brake system 200 may be used to adjust the braking force of brake pressure bars 216 against, for example, tires 292 of trailer 290. In so doing proper braking force may be ensured at tires 292.

At a step 320, a brake control lever is used to disengage the parking brake of the trailer. For example, FIG. 9 shows brake control lever 232 of lever assembly 230 in the “disengaged” position. Here, locking pin 238 may be installed in the lower through-hole 237 of lever assembly 230 and with brake control lever 232 behind pin 238. In doing so, center bar 210 may be pulled forward and away from tires 292. As a result, FIG. 10 shows brake pressure bar 216 not pressed against the surface of tire 292 of trailer 290. That is, no braking force is being applied to tire 292.

At a step 325, the trailer is used as desired, then the trailer is parked. For example, trailer 150 or trailer 290 may be used as desired, then the parked when no longer in use.

At a step 330, a brake control lever is used to engage the parking brake of the trailer. For example, FIG. 11 shows brake control lever 232 of lever assembly 230 in the “engaged” position. Here, locking pin 238 may be installed in the upper through-hole 237 of lever assembly 230 and with brake control lever 232 in front of pin 238. In doing so, center bar 210 may be pushed backward and toward tires 292. As a result, FIG. 12 shows brake pressure bar 216 pressed against the surface of tire 292 of trailer 290. That is, braking force is being applied to tire 292.

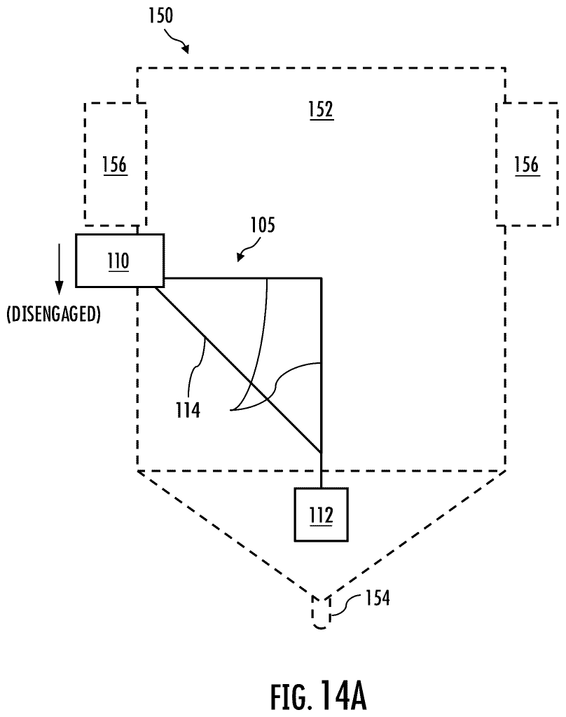

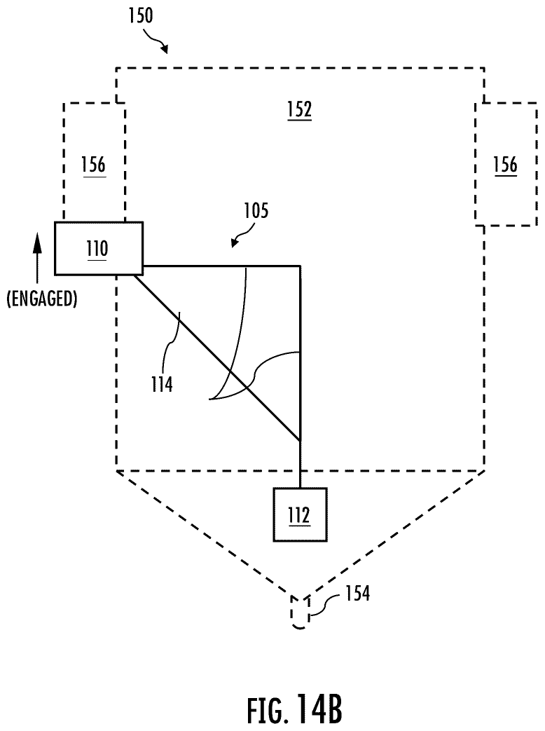

The parking brake system for trailers is not limited to brakes for two tires as shown above in parking brake systems 100, 200. For example, FIG. 14A and FIG. 14B is a schematic view of another example of a parking brake system 105 for a towable trailer, in a disengaged and an engaged state, respectively. The parking brake system 105 is substantially the same as parking brake system 100 shown in FIG. 1A and FIG. 1B except for including one brake (or pressure) bar 110 instead of two.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A parking brake system comprising:
a braking assembly frame having a front end portion and a second end portion;
a pressure bar disposed at the second end portion of the braking assembly frame, wherein the pressure bar is configured to apply a braking force to a tire in a first state and to remove the braking force in a second state; and
a braking control actuator operatively linked to the braking assembly frame, wherein the braking control actuator is configured to cause the braking assembly frame to move the pressure bar between the first state and the second state.

2. The parking brake system of claim 1 wherein the braking control actuator comprises a remote braking controller.

3. The parking brake system of claim 1 wherein the braking control actuator is mechanically coupled to the front end portion of the braking assembly frame.

4. The parking brake system of claim 1 wherein the braking assembly frame is adjustable to accommodate different tire sizes or braking pressures.

5. The parking brake system of claim 1 wherein the braking assembly frame further comprises:
a center bar;
a rear crossbar attached to a distal end of the center bar; and
one or more diagonal support bars, wherein the one or more diagonal support bars are attached at a first end to the center bar and at a second end to the rear crossbar.

6. The parking brake system of claim 5 further comprising an adjustment mechanism, wherein the adjustment mechanism is operatively linked to the braking assembly frame and is configured to adjust the position of the pressure bar relative to a surface of the tire.

7. The parking brake system of claim 6 wherein the adjustment mechanism comprises an adjustment bar, wherein a threaded portion of a proximal end of the center bar is configured to thread into a receiving end portion of the adjustment bar, and wherein a rotation of the adjustment bar corresponds with an adjustment of the position of the pressure bar relative to the surface of the tire.

8. The parking brake system of claim 7 wherein the adjustment bar further comprises a first collar plate and a second collar plate spaced apart from the first collar plate, and wherein the braking control actuator is operatively linked to the braking assembly frame at a point between the first collar plate and the second collar plate.

9. A trailer, comprising:
one or more tires; and
a parking brake system comprising:
a braking assembly frame having a front end portion and a second end portion;
one or more pressure bars disposed at the second end portion of the braking assembly frame, wherein the one or more pressure bars are configured to apply a braking force to one or more of the one or more tires in a first state and to remove the braking force in a second state; and
a braking control actuator operatively linked to the braking assembly frame, wherein the braking control actuator is configured to cause the braking assembly frame to move the one or more pressure bars between the first state and the second state.

10. The trailer of claim 9 wherein the braking control actuator of the parking brake system comprises a remote braking controller.

11. The trailer of claim 9 wherein the braking control actuator of the parking brake system is mechanically coupled to the front end portion of the braking assembly frame.

12. The trailer of claim 9 wherein the braking assembly frame of the parking brake system is adjustable to accommodate different tire sizes or braking pressures.

13. The trailer of claim 9 wherein the braking assembly frame of the parking brake system further comprises:
a center bar;
a rear crossbar attached to a distal end of the center bar; and
one or more diagonal support bars, wherein the one or more diagonal support bars are attached at a first end to the center bar and at a second end to the rear crossbar.

14. The trailer of claim 13 further comprising an adjustment mechanism, wherein the adjustment mechanism is operatively linked to the braking assembly frame and is configured to adjust the position of the one or more pressure bars relative to a surface of one or more of the one or more tires.

15. The trailer of claim 14 wherein the adjustment mechanism comprises an adjustment bar, wherein a threaded portion of a proximal end of the center bar is configured to thread into a receiving end portion of the adjustment bar, and wherein a rotation of the adjustment bar corresponds with an adjustment of the position of the one or more pressure bars relative to the surface of one or more of the one or more tires.

16. The trailer of claim 15 wherein the adjustment bar further comprises a first collar plate and a second collar plate spaced apart from the first collar plate, and wherein the braking control actuator is operatively linked to the braking assembly frame at a point between the first collar plate and the second collar plate.

17. A method of using a parking brake system, the method comprising:
providing a parking brake system, wherein the parking brake system comprises:
a braking assembly frame having a front end portion and a second end portion;
a pressure bar disposed at the second end portion of the braking assembly frame, wherein the pressure bar is configured to apply a braking force to a tire of a trailer in a first state and to remove the braking force in a second state; and
a braking control actuator operatively linked to the braking assembly frame, wherein the braking control actuator is configured to cause the braking assembly frame to move the pressure bar between a first state and a second state;
activating the braking control actuator to the first state to engage the pressure bar with the tire of the trailer; and
deactivating the braking control actuator to the second state to disengage the pressure bar from the tire of the trailer.

18. The method of claim 17, further comprising adjusting the position of the pressure bar relative to the surface of the tire via an adjustment mechanism, wherein the adjustment mechanism is operatively linked to the braking assembly frame and is configured to adjust the position of the pressure bar relative to a surface of the tire.

19. The method of claim 18 wherein the adjustment mechanism comprises an adjustment bar, wherein a threaded portion of a proximal end of the center bar is configured to thread into a receiving end portion of the adjustment bar, and wherein a rotation of the adjustment bar corresponds with an adjustment of the position of the pressure bar relative to the surface of the tire.

20. The method of claim 19 wherein the adjustment bar further comprises a first collar plate and a second collar plate spaced apart from the first collar plate, and wherein the braking control actuator is operatively linked to the braking assembly frame at a point between the first collar plate and the second collar plate.
